(19) United States
(12) Patent Application Publication
(10) Pub. No.: US 2023/0325300 A1
(43) Pub. Date: Oct. 12, 2023

(54) FAULT CHANGE LOCATING METHOD AND APPARATUS, DEVICE, MEDIUM, AND PROGRAM PRODUCT

(71) Applicant: Alipay (Hangzhou) Information Technology Co., Ltd., Hangzhou (CN)

(72) Inventors: Hui LIU, Hangzhou (CN); Rongchao ZHANG, Hangzhou (CN)

(21) Appl. No.: 18/298,987

(22) Filed: Apr. 11, 2023

(30) Foreign Application Priority Data
Apr. 12, 2022 (CN) 202210377556.7

(51) Int. Cl. G06F 11/36

(52) U.S. Cl. CPC G06F 11/362

(57) ABSTRACT

Some implementations of the present specification disclose a fault change locating method and apparatus, a device, a medium, and a program product. The method includes: calculating a text similarity between a description text corresponding to each change in a change set within a determined time period of a complaint time corresponding to a user complaint text and the user complaint text; and determining whether the change in the change set is related to the user complaint text, and if the change in the change set is related to the user complaint text, determining the related change as a fault change corresponding to the user complaint text.

### TECHNICAL FIELD

The present specification relates to the field of communication technologies, and in particular, to a fault change locating method and apparatus, a device, a medium, and a program product.

### BACKGROUND

To fix existing bugs and improve software performance, a technician needs to make frequent changes to the software. Software changes require changes to configuration or code of a system, etc., easily causing a fault. After a fault occurs, it is necessary to quickly locate a change corresponding to the fault, i.e., to determine which historical change causes the fault, so that the technician can quickly roll back the located change to quickly stop the damage and restore the system to normal operation.

At present, a fault can be identified by using a user complaint. However, a process of locating a fault by using a user complaint is relatively long. After a customer service person receives a user complaint, to avoid a false report, the customer service person needs to aggregate information about similar faults in a plurality of user complaints. After determining that a technical problem arises, the customer service person notifies a technician to troubleshoot a plurality of changes one by one, and to determine which released change has caused a fault, i.e., to determine a location of a fault change.

### SUMMARY

Some implementations of the present specification provide a fault change locating method and apparatus, a device, a medium, and a program product. A natural language technology is used to associate a user complaint text with each change based on a text similarity. As long as a user complaint text appears, the user complaint text can be processed to implement short-long text matching, thereby greatly accelerating fault change locating and rectification, and improving efficiency of processing the user complaint text. Technical solutions are as follows:

According to a first aspect, some implementations of the present specification provide a fault change locating method, including: obtaining a user complaint text; determining a change set within a determined time period based on a complaint time of the user complaint text; obtaining a description text corresponding to each change in the change set; calculating a text similarity between the description text corresponding to each change and the user complaint text; and determining a change as a fault change corresponding to the user complaint text if a text similarity between a description text corresponding to the change and the user complaint text is greater than or equal to a first determined threshold.

In some possible implementations, the description text includes at least one sentence; and the calculating a text similarity between the description text corresponding to each change and the user complaint text includes: calculating a first word overlap score between the user complaint text and each sentence in the description text corresponding to each change, where the first word overlap score is used to represent a correlation between the user complaint text and each sentence in the description text corresponding to each change; extracting N sentences with highest first word overlap scores from the description text corresponding to each change, where N is a positive integer; and calculating the text similarity between the description text corresponding to each change and the user complaint text based on the N sentences corresponding to each change.

In some possible implementations, the calculating the text similarity between the description text corresponding to each change and the user complaint text based on the N sentences corresponding to each change includes: calculating N text similarities between the N sentences corresponding to each change and the user complaint text; and determining the text similarity between the description text corresponding to each change and the user complaint text based on L highest text similarities among the N text similarities, where L is a positive integer greater than 0 and less than or equal to N.

In some possible implementations, the determining the text similarity between the description text corresponding to each change and the user complaint text based on L highest text similarities among the N text similarities includes: determining the text similarity between the description text corresponding to each change and the user complaint text based on the L highest text similarities among the N text similarities and L first word overlap scores between L sentences corresponding to the L highest text similarities and the user complaint text.

In some possible implementations, the description text includes a plurality of sentences; and the calculating a text similarity between the description text corresponding to each change and the user complaint text includes: stitching all sentences in the description text corresponding to each change according to a first determined rule to obtain at least one target text corresponding to the description text, where the target text includes at least one of the sentences; calculating a second word overlap score between the user complaint text and each target text corresponding to the description text, where the second word overlap score is used to represent a correlation between the user complaint text and each target text corresponding to the description text; extracting M target texts with highest second word overlap scores from the at least one target text corresponding to the description text, where M is a positive integer; and calculating the text similarity between the description text corresponding to each change and the user complaint text based on the M target texts corresponding to the description text of each change.

In some possible implementations, the calculating the text similarity between the description text corresponding to each change and the user complaint text based on the M target texts corresponding to the description text of each change includes: calculating M text similarities between the M target texts corresponding to each change and the user complaint text; and determining the text similarity between the description text corresponding to each change and the user complaint text based on K highest text similarities among the M text similarities, where K is a positive integer greater than 0 and less than or equal to M.

In some possible implementations, the determining the text similarity between the description text corresponding to each change and the user complaint text based on K highest text similarities among the M text similarities includes: determining the text similarity between the description text corresponding to each change and the user complaint text based on the K highest text similarities among the M text similarities and K second word overlap scores between K target texts corresponding to the K highest text similarities and the user complaint text.

In some possible implementations, after the obtaining a user complaint text and before the calculating a text similarity between the description text corresponding to each change and the user complaint text, the method further includes: filtering the user complaint text and the description text corresponding to each change based on a determined stop word library and according to a second determined rule to obtain a filtered user complaint text and a filtered description text corresponding to each change; and the calculating a text similarity between the description text corresponding to each change and the user complaint text includes: calculating a text similarity between the filtered description text corresponding to each change and the filtered user complaint text.

In some possible implementations, after the obtaining a user complaint text and before the calculating a text similarity between the description text corresponding to each change and the user complaint text, the method further includes: determining X historical user complaint texts made before the complaint time of the user complaint texts, where X is a positive integer; calculating a text similarity between the user complaint text and each of the X historical user complaint texts; and if text similarities between Y historical user complaint texts and the user complaint text are greater than or equal to a second determined threshold, stitching the Y historical user complaint texts and the user complaint text according to a third determined rule to obtain a target complaint text, where Y is a positive integer greater than 0 and less than or equal to X; and the calculating a text similarity between the description text corresponding to each change and the user complaint text includes: calculating a text similarity between the description text corresponding to each change and the target complaint text; and the determining a change as a fault change corresponding to the user complaint text if a text similarity between a description text corresponding to the change and the user complaint text is greater than or equal to a first determined threshold includes: if a text similarity between a description text corresponding to a change and the target complaint text is greater than or equal to the first determined threshold, determining the change as a fault change corresponding to the user complaint text and the Y historical user complaint texts.

According to a second aspect, some implementations of the present specification provide a fault change locating apparatus, including: an obtaining module, configured to obtain a user complaint text; a first determining module, configured to determine a change set within a determined time period based on a complaint time of the user complaint text, where the obtaining module is further configured to obtain a description text corresponding to each change in the change set; a first calculation module, configured to calculate a text similarity between the description text corresponding to each change and the user complaint text; and a second determining module, configured to determine a change as a fault change corresponding to the user complaint text if a text similarity between a description text corresponding to the change and the user complaint text is greater than or equal to a first determined threshold.

In some possible implementations, the description text includes at least one sentence; and the first calculation module includes: a first calculation unit, configured to calculate a first word overlap score between the user complaint text and each sentence in the description text corresponding to each change, where the first word overlap score is used to represent a correlation between the user complaint text and each sentence in the description text corresponding to each change; a first extraction unit, configured to extract N sentences with highest first word overlap scores from the description text corresponding to each change, where N is a positive integer; and a second calculation unit, configured to calculate the text similarity between the description text corresponding to each change and the user complaint text based on the N sentences corresponding to each change.

In some possible implementations, the second calculation unit is in some implementations configured to: calculate N text similarities between the N sentences corresponding to each change and the user complaint text; and determine the text similarity between the description text corresponding to each change and the user complaint text based on L highest text similarities among the N text similarities, where L is a positive integer greater than 0 and less than or equal to N.

In some possible implementations, when determining the text similarity between the description text corresponding to each change and the user complaint text based on L highest text similarities among the N text similarities, the second calculation unit is in some implementations configured to: determine the text similarity between the description text corresponding to each change and the user complaint text based on the L highest text similarities among the N text similarities and L first word overlap scores between L sentences corresponding to the L highest text similarities and the user complaint text.

In some possible implementations, the description text includes a plurality of sentences; and the first calculation module further includes: a stitching unit, configured to stitch all sentences in the description text corresponding to each change according to a first determined rule to obtain at least one target text corresponding to the description text, where the target text includes at least one of the sentences; a third calculation unit, configured to calculate a second word overlap score between the user complaint text and each target text corresponding to the description text, where the second word overlap score is used to represent a correlation between the user complaint text and each target text corresponding to the description text; a second extraction unit, configured to extract M target texts with highest second word overlap scores from the at least one target text corresponding to the description text, where M is a positive integer; and a fourth calculation unit, configured to calculate the text similarity between the description text corresponding to each change and the user complaint text based on the M target texts corresponding to the description text of each change.

In some possible implementations, the fourth calculation unit is in some implementations configured to: calculate M text similarities between the M target texts corresponding to each change and the user complaint text; and determine the text similarity between the description text corresponding to each change and the user complaint text based on K highest text similarities among the M text similarities, where K is a positive integer greater than 0 and less than or equal to M.

In some possible implementations, when determining the text similarity between the description text corresponding to each change and the user complaint text based on K highest text similarities among the M text similarities, the fourth calculation unit is in some implementations configured to: determine the text similarity between the description text corresponding to each change and the user complaint text based on the K highest text similarities among the M text similarities and K second word overlap scores between K target texts corresponding to the K highest text similarities and the user complaint text.

In some possible implementations, the fault change locating apparatus further includes: a filtering module, configured to filter the user complaint text and the description text corresponding to each change based on a determined stop word library and according to a second determined rule to obtain a filtered user complaint text and a filtered description text corresponding to each change; and the first calculation module is in some implementations configured to: calculate a text similarity between the filtered description text corresponding to each change and the filtered user complaint text.

In some possible implementations, the fault change locating apparatus further includes: a third determining module, configured to determine X historical user complaint texts made before the complaint time of the user complaint texts, where X is a positive integer; a second calculation module, configured to calculate a text similarity between the user complaint text and each of the X historical user complaint texts; and a stitching module, configured to: if text similarities between Y historical user complaint texts and the user complaint text are greater than or equal to a second determined threshold, stitch the Y historical user complaint texts and the user complaint text according to a third determined rule to obtain a target complaint text, where Y is a positive integer greater than 0 and less than or equal to X; the first calculation module is further configured to calculate a text similarity between the description text corresponding to each change and the target complaint text; and the second determining module is further configured to: if a text similarity between a description text corresponding to a change and the target complaint text is greater than or equal to the first determined threshold, determine the change as a fault change corresponding to the user complaint text and the Y historical user complaint texts.

According to a third aspect, some implementations of the present specification provide an electronic device, including a processor and a memory, where the processor is connected to the memory; the memory is configured to store executable program code; and the processor runs a program corresponding to the executable program code by reading the executable program code stored in the memory, to perform the method according to any one of the first aspect or some possible implementations of the first aspect in some implementations of the present specification.

According to a fourth aspect, some implementations of the present specification provide a computer storage medium. The computer storage medium stores instructions. The instructions are loaded and executed by a processor to perform the method according to any one of the first aspect or some possible implementations of the first aspect in some implementations of the present specification.

According to a fifth aspect, some implementations of the present specification provide a computer program product including instructions. When the computer program product runs on a computer or a processor, the computer or the processor is enabled to perform the fault change locating method according to any one of the first aspect or some possible implementations of the first aspect in some implementations of the present specification.

According to some implementations of the present specification, a change set within a determined time period is determined according to a complaint time of a user complaint text, a text similarity between a description text corresponding to each change in the change set and the user complaint text is calculated, and then a change with a text similarity to the user complaint text greater than or equal to a first determined threshold is determined as a fault change corresponding to the user complaint text. As such, a natural language technology is used to associate the user complaint text with each change based on a text similarity. As long as a user complaint text appears, the user complaint text can be processed to implement matching between a short text (the user complaint text) and a long text (a description text corresponding to a change), thereby greatly accelerating fault change locating and rectification, shortening a troubleshooting time of a technician, and improving efficiency of processing the user complaint text.

### BRIEF DESCRIPTION OF DRAWINGS

To describe the technical solutions in some implementations of the present specification more clearly, the following briefly describes accompanying drawings required for describing some implementations. Clearly, the accompanying drawings in the following description show merely some implementations of the present specification, and a person of ordinary skill in the art can still derive other accompanying drawings from these accompanying drawings without making innovative efforts.

FIG. 1 is a schematic architectural diagram of a fault change locating system according to some example implementations of the present specification;

FIG. 2 is a schematic diagram of a process from identifying a fault by a user to rectifying the fault by a technician according to a related technology;

FIG. 3 is a schematic flowchart of a fault change locating method according to some example implementations of the present specification;

FIG. 4 is a schematic diagram of a change and a description text corresponding to the change according to some example implementations of the present specification;

FIG. 5 is a schematic diagram of an implementation process of a text similarity model according to some example implementations of the present specification;

FIG. 6 is a schematic diagram of an implementation process of another text similarity model according to some example implementations of the present specification;

FIG. 7 is a schematic flowchart of another fault change locating method according to some example implementations of the present specification;

FIG. 8 is a schematic structural diagram of a fault change locating apparatus according to some example implementations of the present specification; and

FIG. 9 is a schematic structural diagram of an electronic device according to some example implementations of the present specification.

### DESCRIPTION OF IMPLEMENTATIONS

The following clearly and fully describes the technical solutions in some implementations of the present specification with reference to the accompanying drawings in some implementations of the present specification.

In the present specification, claims, and accompanying drawings of the present specification, the terms “first”, “second”, “third”, and the like are intended to distinguish between different objects but do not indicate a particular order. In addition, the terms “including” and “having” and any variants thereof are intended to cover non-exclusive inclusion. For example, a process, a method, a system, a product, or a device that includes a series of steps or units is not limited to the listed steps or units, but in some implementations further includes other unlisted steps or units, or in some implementations further includes another inherent step or unit of the process, the method, the product, or the device.

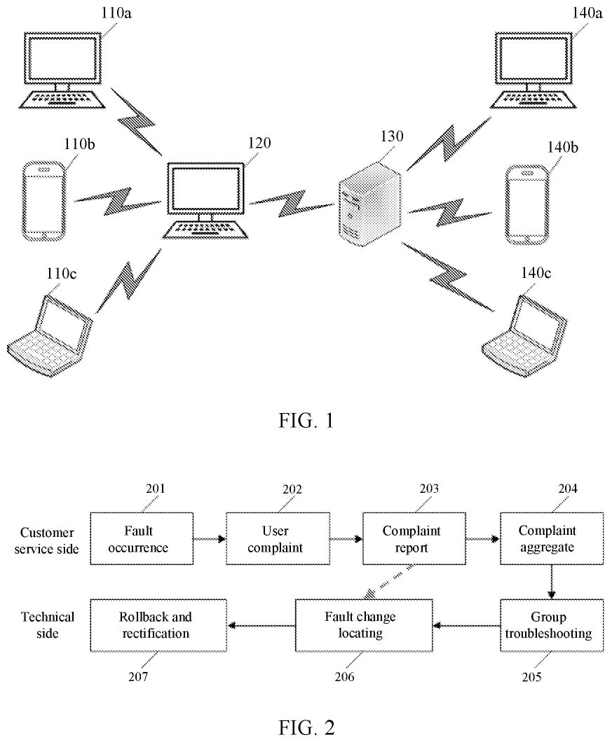

FIG. 1 is a schematic architectural diagram of a fault change locating system according to some example implementations of the present specification. As shown in FIG. 1, the fault change locating system may include a first terminal cluster, a second terminal 120, a server 130, and a third terminal cluster.

The first terminal cluster may be a user terminal, in some implementations including one or more user terminals, where the plurality of user terminals may include a user terminal 110a, a user terminal 110b, a user terminal 110c, . . . , and so on. Software of a user edition may be installed in the first terminal cluster to perform functions such as inputting a user complaint text or complaint voice by a user online. Any user terminal in the first terminal cluster may establish a data relationship with a network, and establish a data connection relationship with the second terminal 120 through the network, such as sending a user complaint text, initiating a complaint call, and so on. Any user terminal in the first terminal cluster may be, but is not limited to, a device such as a mobile phone, a tablet computer, or a notebook computer on which software of a user edition is installed.

The second terminal 120 may be a customer service terminal, and may in some implementations include one or more customer service terminals. Software of a customer service edition may be installed in the second terminal 120 to perform functions such as obtaining a user complaint text or complaint voice, receiving a complaint call, and converting content of the complaint call into a complaint text by a customer service person online. The second terminal 120 may establish a data relationship with the network and establish a data connection relationship with any user terminal in the first terminal cluster through the network, such as receiving a user complaint text or receiving a complaint call. The second terminal 120 may also establish a data connection relationship with the server 130 through the network, such as sending a user complaint text or complaint call. The second terminal 120 may be, but is not limited to, a device such as a mobile phone, a tablet computer, or a notebook computer on which software of a customer service edition is installed.

The third terminal cluster may be a technician terminal, in some implementations including one or more technician terminals, where the plurality of technician terminals may include a technician terminal 140a, a technician terminal 140b, a technician terminal 140c, . . . , and so on. Software of a technician edition may be installed in the third terminal cluster to perform functions such as receiving a fault change, and troubleshooting and rectifying a fault change by a technician online. Any technician terminal in the third terminal cluster may establish a data relationship with the network, and establish a data connection relationship with the server 130 through the network, such as sending a description text corresponding to a change and receiving a determined fault change. Any technician terminal in the third terminal cluster may be, but is not limited to, a device such as a mobile phone, a tablet computer, or a notebook computer on which software of a technician edition is installed.

The server 130 may be a server capable of providing a plurality of fault change locating methods, may receive data such as a user complaint text sent by the network or the second terminal 120, and may receive a description text or the like corresponding to a change sent by any technician terminal in the third terminal cluster, and store the description texts corresponding to the changes sent by all the technician terminals in a database, and then determine a fault change corresponding to the user complaint text based on the user complaint text and the description text corresponding to each change in the change set within the determined (e.g., predetermined, dynamically determined, or experimentally determined) time period of the complaint time of the user complaint text. The server 130 may also send the user complaint text or the like to any technician terminal in the third terminal cluster or to a technician terminal of the fault change corresponding to the user complaint text. The server 130 may be, but is not limited to, a hardware server, a virtual server, a cloud server, and the like.

The network may be a medium providing a communication link between the second terminal 120 and any user terminal in the first terminal cluster, between the second terminal 120 and the server 130, and between the server 130 and any technician terminal in the third terminal cluster, or may be an internet including a network device and a transmission medium, but is not limited thereto. The transmission medium may be a wired link (for example without limitation to, a coaxial cable, an optical fiber, a digital subscriber line (DSL), etc.) or a wireless link (for example without limitation to, a wireless fidelity (Wi-Fi), Bluetooth, a mobile device network, etc.).

It will be appreciated that quantities of the first terminal clusters, the second terminals 120, the servers 130, and the third terminal clusters in the fault change locating system shown in FIG. 1 are merely examples, and in some specific implementations, the fault change locating system may include any quantities of user terminals, customer service terminals, technician terminals, and servers. This is not in some implementations limited in some implementations of the present specification. Serving as examples instead of limitation, the second terminal 120 may be a second terminal cluster that includes a plurality of second terminals (customer service terminals), and the server 130 may be a server cluster that includes a plurality of servers.

The following describes an overall process from identifying a fault by a user to rectifying the fault by a technician with reference to FIG. 1. FIG. 2 is a schematic diagram of a process from identifying a fault by a user to rectifying the fault by a technician according to a related technology; As shown in FIG. 2, if software is faulty (201, fault occurrence), the customer service person receives the user's phone complaint and/or online complaint (202, user complaint), and then the customer service person needs to submit and report the received user's phone complaint and/or online complaint text manually (203, complaint report). Since a complaint call or a complaint text may be a false report, it is necessary for a plurality of customer service persons or on-site overall control persons to aggregate the complaint calls and/or the complaint texts of similar faults (204, complaint aggregate). After a technical problem is determined, a technician is notified, and a group of technicians perform thorough troubleshooting (205, group troubleshooting) to determine an actual location of the fault change (206, fault change locating), and the technician corresponding to the fault change performs rollback and rectification (207, rollback and rectification). Due to the large quantity of changes and the large quantity of corresponding technicians, it takes time to wait for the occurrence of multiple similar faults (204, complaint aggregate) before starting to process a complaint that is determined to be a technical problem. In addition, it also takes a lot of time to determine which released change has caused a fault. In other words, the existing process from identifying a fault by a user to rectifying the fault by a technician is excessively long, and the workload of the customer service person and the technician is extremely heavy. As a result, some user complaint calls or complaint texts may not be processed in a timely manner.

However, according to some implementations of the present specification, machine learning and natural language processing technologies are used to associate the text and the complaint text (short text) corresponding to the complaint call of the user with the related description (long text) given when the technician changes the system or code in terms of a time sequence, i.e., the text similarity between the short text and the long text is calculated, and whether the complaint of the user is related to a specific change is determined. Therefore, the technician can be aware of the quantity of related complaints of the user as soon as the change is released, so that the fault change locating is greatly accelerated, and each user complaint can be processed in a timely manner, i.e., whether the user complaint is a technical problem can be determined without performing step 204 (complaint aggregate). If the user complaint is a technical problem, the machine can quickly determine the fault change corresponding to the user complaint without performing 205 (group troubleshooting), and then the technician corresponding to the fault change is notified to perform rollback and rectification in a timely manner.

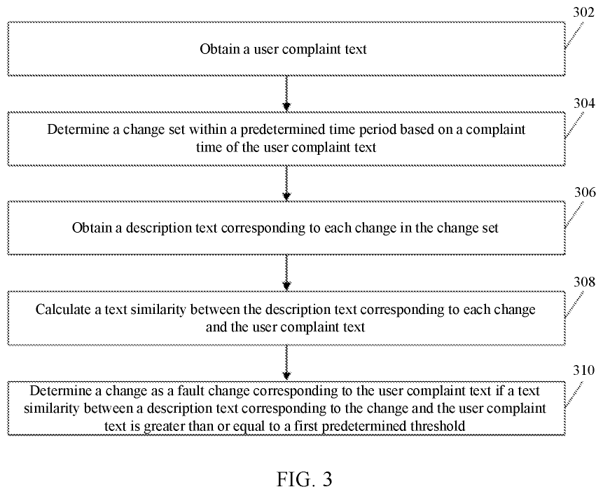

The following describes a fault change locating method according to some implementations of the present specification with reference to FIG. 1 and FIG. 2. FIG. 3 is a schematic flowchart of a fault change locating method according to some example implementations of the present specification. As shown in FIG. 3, the fault change locating method includes the following steps:

Step 302: Obtain a user complaint text.

In some implementations, after receiving a user complaint call, the customer service terminal may first convert voice data of the user complaint call into a user complaint text, and then send the complaint text to a server, so that the server can obtain the user complaint text. Alternatively, the customer service terminal may directly send the voice data of the user complaint call to the server, and the server converts the voice data into the user complaint text. Alternatively, the server may directly receive the user complaint text sent by the customer service terminal or the user terminal through the network, which is not limited in the present specification.

Step 304: Determine a change set within a determined (e.g., predetermined, dynamically determined, or experimentally determined) time period based on a complaint time of the user complaint text.

In some implementations, the user complaint text includes a corresponding complaint time. The complaint time is used to represent a time at which the user starts making the complaint call or starts sending the complaint text online. The release times corresponding to different changes may be different, and a plurality of changes may happen every day. In terms of a time sequence, there is a higher probability that a change released before and close to the complaint time of the user complaint text is correlated with the user complaint text. Therefore, a change set within a determined time period of the complaint time can be determined based on the complaint time of the user complaint text. The determined time period may be 1 minute, 8 hours, 3 days, 1 month, or the like, and the present specification is not limited thereto. The change set includes all changes within the determined time period before the complaint time of the user complaint text.

For example, if the determined time period is 1 day and the complaint time of the user complaint text is 00:00:00 on Jan. 26, 2022, all changes released between 00:00:00 on Jan. 25, 2022 and 00:00:00 on Jan. 26, 2022 may be determined as a change set within the determined time period.

Step 306: Obtain a description text corresponding to each change in the change set.

In some implementations, the server may find the description text corresponding to each change in the change set from the description text corresponding to all changes stored in advance based on the name corresponding to each change in the change set. Changes may include, but are not limited to, code changes, configuration changes, system changes, interface changes, and the like.

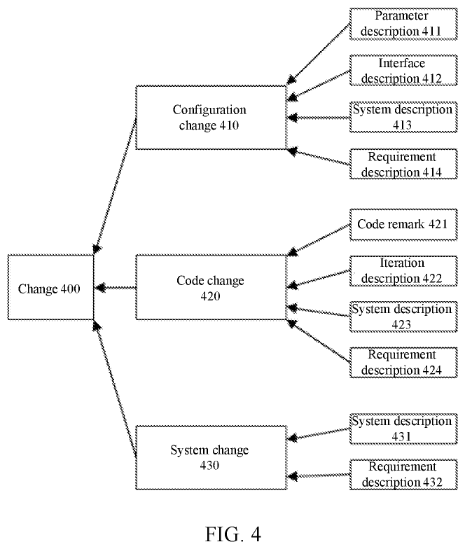

For example, as shown in FIG. 4, the change 400 includes a configuration change 410, a code change 420, and a system change 430. The description text corresponding to the configuration change 410 includes a parameter description 411, an interface description 412, and a system description 413 corresponding to the current change written by the technician, and a requirement description 414 corresponding to the current change written by a non-technical person such as a product manager. The description text corresponding to the code change 420 includes a code remark 421, an iteration description 422, and a system description 423 corresponding to the current change written by the technician, and a requirement description 424 corresponding to the current change written by a non-technical person such as a product manager. The description text corresponding to the system change 430 includes a system description 431 corresponding to the current change written by the technician, and a requirement description 432 corresponding to the current change written by a non-technical person such as a product manager.

Step 308: Calculate a text similarity between the description text corresponding to each change and the user complaint text.

In some implementations, the description text corresponding to each change and the user complaint text may be directly input into the BERT text similarity model, so as to output the text similarity between the description text corresponding to each change and the user complaint text. The BERT text similarity model is obtained through training based on a text similarity between each user complaint text and each of description texts corresponding to a plurality of changes, a plurality of user complaint texts, and a description text corresponding to each change.

In some implementations, to improve the accuracy of the BERT text similarity model, the user complaint text and the description text corresponding to each change may be first filtered based on the determined (e.g., predetermined, dynamically determined, or experimentally determined) stop word library and according to the second determined rule (e.g., predetermined, dynamically determined, or experimentally determined) to obtain a filtered user complaint text and a filtered description text corresponding to each change, and then a text similarity between the filtered description text corresponding to each change and the filtered user complaint text is calculated. The second determined rule may be filtering out words in the user complaint text and the description text that are the same as the stop words in the determined stop word library. The stop words are used to represent words that are unrelated to the description of the fault and the change, such as thank you, good, etc. To prevent descriptive words and the like related to software in the description text corresponding to each change from being filtered out and to avoid decreasing the accuracy of fault change locating, the second determined rule may be filtering out the stop words in the user complaint text and the description text based on the determined stop word library, while retaining the description related to the software in the description text, for example, the description of the technical terms such as the configuration and the system in the description text. In other words, to prevent some words in the description related to the software that are the same as the stop words in the determined stop word library from being filtered out, a protection field may be added to the words, which is not limited in the present specification.

Step 310: Determine a change as a fault change corresponding to the user complaint text if a text similarity between a description text corresponding to the change and the user complaint text is greater than or equal to a first determined threshold (e.g., predetermined, dynamically determined, or experimentally determined).

In some implementations, the change corresponding to the description text with a text similarity to the user complaint text greater than or equal to the first determined threshold may be determined as the fault change corresponding to the user complaint text. In other words, it is possible that the above fault change has caused the problem to occur when the user uses the software, and as a result, the complaint is raised, i.e., the above user complaint text is generated. The first determined threshold may be 0.1, 0.9, or the like, which is not limited in the present specification. The fault change corresponding to the user complaint text includes at least one change. After determining at least one fault change related to the user complaint text, the server may send the user complaint text and the corresponding at least one fault change to a technician corresponding to each fault change for troubleshooting, rollback, and rectification.

According to some implementations of the present specification, a change set within a determined time period is determined according to a complaint time of a user complaint text, a text similarity between a description text corresponding to each change in the change set and the user complaint text is calculated, and then a change with a text similarity to the user complaint text greater than or equal to a first determined threshold is determined as a fault change corresponding to the user complaint text. As such, a natural language technology is used to associate the user complaint text with each change based on a text similarity. As long as a user complaint text appears, the user complaint text can be processed to implement matching between a short text (the user complaint text) and a long text (a description text corresponding to a change), so that the technician only needs to troubleshoot, roll back, and rectify the fault change associated with the user complaint text, and does not need to troubleshoot all changes, thereby greatly accelerating fault change locating and rectification, shortening a troubleshooting time of a technician, and improving efficiency of processing the user complaint text.

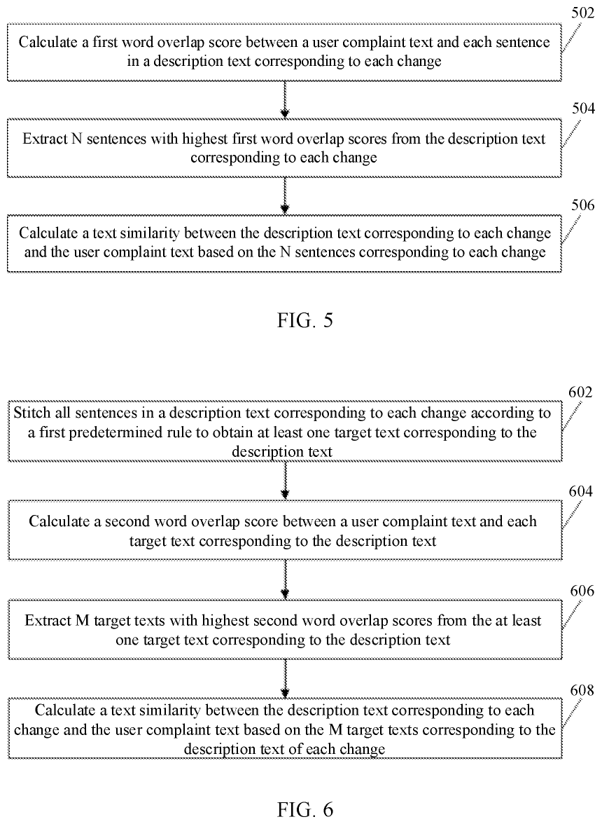

The conventional BERT text similarity model (BERT model) can process only a short text with a length less than 512, and the length of the user complaint text is generally less than 512, and the length of the description text corresponding to each change is far greater than 512. To enable the BERT text similarity model to calculate the similarity between the short text and the long text, matching is usually performed by compressing the long text or extracting keywords or key sentences that include keywords from the long text. However, all of the above methods result in the loss of a large quantity of meaningful texts in the description text corresponding to the change, thereby affecting the accuracy of the BERT text similarity model in calculating the short-long text similarity, and resulting in low accuracy of fault change locating. To solve the above-mentioned problems, a specific implementation process of calculating the text similarity between the description text corresponding to each change and the user complaint text in step 308 of the fault change locating method provided in some implementations of the present specification is described below with reference to FIG. 1 to FIG. 4. FIG. 5 is a schematic diagram of an implementation process of a text similarity model according to some example implementations of the present specification. As shown in FIG. 5, the implementation process of the text similarity model includes the following steps:

Step 502: Calculate a first word overlap score between the user complaint text and each sentence in the description text corresponding to each change.

In some implementations, the description text corresponding to the change includes at least one sentence. The description text corresponding to each change may be first segmented based on a period, and then word overlap scoring is performed on the user complaint text and each sentence in the description text corresponding to each change, i.e., the first word overlap score is calculated, which is a score having the same or similar words between the user complaint text and each sentence in the description text corresponding to each change. The first word overlap score is used to represent the correlation between the user complaint text and each sentence in the description text corresponding to each change.

Step 504: Extract N sentences with highest first word overlap scores from the description text corresponding to each change.

In some implementations, after the first word overlap score between the user complaint text and each sentence in the description text corresponding to each change is calculated, the N sentences with highest first word overlap scores in the description text corresponding to each change can be extracted. N is a positive integer.

For example, five sentences with highest first word overlap scores can be extracted from the description text corresponding to each change.

Step 506: Calculate the text similarity between the description text corresponding to each change and the user complaint text based on the N sentences corresponding to each change.

In some implementations, N text similarities between the N sentences with highest first word overlap scores corresponding to each change and the user complaint text may be calculated first. To be specific, the N sentences with highest first word overlap scores corresponding to each change and the user complaint text may be input into the BERT text similarity model respectively, so as to output the N text similarities between the N sentences corresponding to each change and the user complaint text. Then, the text similarity between the description text corresponding to each change and the user complaint text is determined based on L highest text similarities among the N text similarities. L is a positive integer greater than 0 and less than or equal to N.

For example, an average value of L highest text similarities among the N text similarities corresponding to each change may be calculated, and the average value is determined as the text similarity between the description text corresponding to each change and the user complaint text. Alternatively, weighted summation may be performed on the L highest text similarities among the N text similarities corresponding to each change to obtain the text similarity between the description text corresponding to each change and the user complaint text, which is not limited in some implementations of the present specification.

In some implementations, after the N text similarities between the N sentences with highest first word overlap scores corresponding to each change and the user complaint text are calculated, the text similarity between the description text corresponding to each change and the user complaint text may be further determined based on the L highest text similarities among the N text similarities and L first word overlap scores between L sentences corresponding to the L highest text similarities and the user complaint text. To be specific, weighted fusion may be performed on the L highest text similarities among the N text similarities and L first word overlap scores between L sentences corresponding to the L highest text similarities and the user complaint text, to obtain the text similarity between the description text corresponding to each change and the user complaint text. L is a positive integer greater than 0 and less than or equal to N.

According to some implementations of the present specification, the text similarity between the description text corresponding to each change and the user complaint text can be determined jointly based on the L highest text similarities among the N text similarities corresponding to the N sentences with highest first word overlap scores in the description text of each change and the L first word overlap scores between the L sentences corresponding to the L highest text similarities and the user complaint text, so that the accuracy of calculating the text similarity can be further improved, thereby further improving the accuracy of fault change locating.

Different persons have different habits for writing description texts. Sometimes a period is written and sometimes a semicolon is written, and sentence lengths are inconsistent. If the description text corresponding to each change is segmented based on the period, and the text similarity between the description text corresponding to each change and the user complaint text is then calculated based on some sentences in the description text corresponding to each change, a case may occur in which the text semantics are cut due to use of unnecessary periods during writing, and the description text corresponding to each change includes a plurality of sentences, i.e., the calculation of the first word overlap score needs to be performed a plurality of times for each sentence, resulting in an excessive large amount of calculation. Consequently, the efficiency of fault change locating is not high enough, the accuracy of text similarity calculation is not high enough, and the accuracy of fault change locating is not high enough. To solve the above-mentioned problems, another specific implementation process of calculating the text similarity between the description text corresponding to each change and the user complaint text in step 308 of the fault change locating method provided in some implementations of the present specification is described below with reference to FIG. 1 to FIG. 4. FIG. 6 is a schematic diagram of another implementation process of a text similarity model according to some example implementations of the present specification. As shown in FIG. 6, the implementation process of the text similarity model includes the following steps:

Step 602: Stitch all sentences in the description text corresponding to each change according to a first determined rule (e.g., predetermined, dynamically determined, or experimentally determined) to obtain at least one target text corresponding to the description text.

In some implementations, the description text corresponding to each change includes a plurality of sentences. All sentences in the description text corresponding to each change may be stitched according to a first determined rule to obtain at least one target text corresponding to the description text. The target text includes at least one of the sentences in the description text. The first determined rule may be stitching a plurality of sentences in the description text corresponding to each change in the order in the description text until the length of the target text obtained through the stitching is closest to or equal to the determined length. The sentence is a short sentence with a length smaller than a determined threshold. The determined threshold may be any value greater than 1 and less than or equal to 512, for example, 256, 200, or 512, which is not limited in the present specification. The first determined rule may alternatively be stitching the sentences or characters in the description text in the order in the description text until the length of the target text obtained through the stitching is closest to or equal to the determined length, which is not limited in some implementations of the present specification. The determined length may be the maximum text length 512 for training the BERT text similarity model, or may be any length less than 512, for example, 256 or 400, which is not limited in some implementations of the present specification.

Step 604: Calculate a second word overlap score between the user complaint text and each target text corresponding to the description text.

In some implementations, word overlap scoring may be performed on the user complaint text and each target text in the at least one target text corresponding to each description text. To be specific, a second word overlap score is calculated, which is a score having the same or similar words between the user complaint text and each target text in the at least one target text corresponding to each description text. The second word overlap score is used to represent the correlation between the user complaint text and each target text corresponding to the description text.

Step 606: Extract M target texts with highest second word overlap scores from the at least one target text corresponding to the description text.

In some implementations, after the second word overlap score between the user complaint text and each of the at least one target text corresponding to the description text of each change is calculated, the M target texts with highest second word overlap scores among the at least one target text corresponding to the description text of each change can be extracted. M is a positive integer, and M is less than or equal to the total quantity of all target texts corresponding to the description text.

For example, if the sentences in the description text corresponding to a change are stitched to obtain 20 target texts, 3 target texts with highest second word overlap scores can be extracted from the 20 target texts corresponding to the description text.

Step 608: Calculate the text similarity between the description text corresponding to each change and the user complaint text based on the M target texts corresponding to the description text of each change.

In some implementations, the M text similarities between the M target texts with highest second word overlap scores corresponding to each description text and the user complaint text may be calculated first, i.e., the M target texts with highest second word overlap scores corresponding to each description text and the user complaint text may be input into the BERT text similarity model, so as to output the M text similarities between the M target texts corresponding to each description text and the user complaint text. Then, the text similarity between the description text corresponding to each change and the user complaint text is determined based on K highest text similarities among the M text similarities. K is a positive integer greater than 0 and less than or equal to M.

For example, an average value of K highest text similarities among the M text similarities corresponding to each change may be calculated, and the average value is determined as the text similarity between the description text corresponding to each change and the user complaint text. Alternatively, weighted summation may be performed on the K highest text similarities among the M text similarities corresponding to each change to obtain the text similarity between the description text corresponding to each change and the user complaint text, which is not limited in some implementations of the present specification.

In some implementations, after the M text similarities between the M target texts with highest second word overlap scores corresponding to each change and the user complaint text are calculated, the text similarity between the description text corresponding to each change and the user complaint text may be further determined based on the K highest text similarities among the M text similarities and K second word overlap scores between K target texts corresponding to the K highest text similarities and the user complaint text. To be specific, weighted fusion may be performed on the K highest text similarities among the M text similarities and K second word overlap scores between K target texts corresponding to the K highest text similarities and the user complaint text, to obtain the text similarity between the description text corresponding to each change and the user complaint text. K is a positive integer greater than 0 and less than or equal to M.

According to some implementations of the present specification, the description text is segmented without following original periods, and instead, calculation of the second word overlap score starts only after the sentences in the description text corresponding to the change are stitched to approach or reach the maximum length for training the BERT text similarity model, and the text similarity between the description text corresponding to each change and the user complaint text is calculated based on the M target texts with highest second word overlap scores corresponding to the description text of each change. As such, a case in which the text semantics are cut due to use of unnecessary periods during writing is avoided, and the calculation amount of calculating the second word overlap score is reduced, thereby improving the efficiency of fault change locating, further improving the accuracy of calculating the text similarity, and further improving the accuracy of fault change locating.

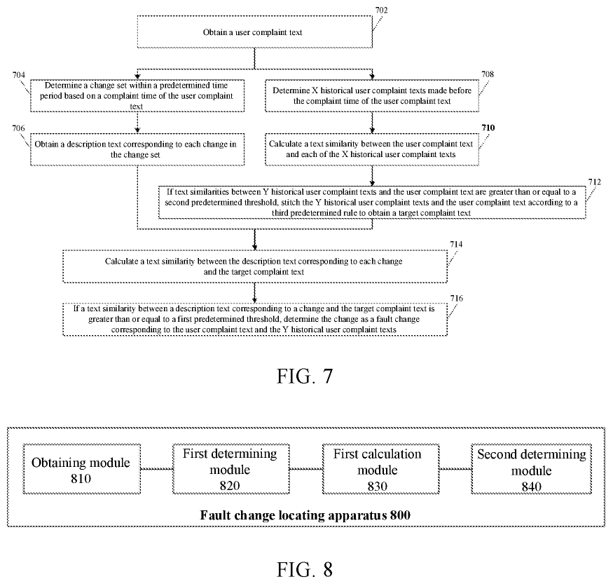

Since the above-described unsupervised BERT text similarity model does not ignore any possibility, and associates the user complaint text with the change as much as possible, and the description given by one user may be incomplete, the technician in attendance needs to troubleshoot a large quantity of fault changes suspected to be associated with a plurality of similar and different user complaint texts on a daily basis. To solve the above-mentioned problems, the following describes a fault change locating method according to some implementations of the present specification with reference to FIG. 1 and FIG. 2. FIG. 7 is a schematic flowchart of another fault change locating method according to some example implementations of the present specification. As shown in FIG. 7, the fault change locating method includes the following steps:

Step 702: Obtain a user complaint text.

In some implementations, step 702 is consistent with step 302, and details are omitted for simplicity.

Step 704: Determine a change set within a determined time period based on a complaint time of the user complaint text.

In some implementations, step 704 is consistent with step 304, and details are omitted for simplicity.

Step 706: Obtain a description text corresponding to each change in the change set.

In some implementations, step 706 is consistent with step 306, and details are omitted for simplicity.

Step 708: Determine X historical user complaint texts made before the complaint time of the user complaint texts.

In some implementations, the X historical user complaint texts made before the complaint time of the current user complaint text and closest to the complaint time of the user complaint text can be found from all the obtained user complaint texts. X is a positive integer.

For example, X may be 50, 100, 200, or the like, which is not limited in some implementations of the present specification.

Step 710: Calculate a text similarity between the user complaint text and each of the X historical user complaint texts.

In some implementations, the user complaint text and the X historical user complaint texts may be input into the trained BERT text similarity model in some above-described implementations, so as to output the text similarity between the user complaint text and each of the X historical user complaint texts.

Step 712: If text similarities between Y historical user complaint texts and the user complaint text are greater than or equal to a second determined threshold (e.g., predetermined, dynamically determined, or experimentally determined), stitch the Y historical user complaint texts and the user complaint text according to a third determined rule to obtain a target complaint text.

In some implementations, all historical user complaint texts with text similarities to the user complaint text greater than or equal to the second determined threshold in the X historical user complaint texts, i.e., the Y historical user complaint texts, can be stitched with the user complaint text according to the third determined rule to obtain the target complaint text. The third determined rule may be stitching the Y historical user complaint texts and the user complaint text based on a sequence of complaint times, or may be stitching the Y historical user complaint texts and the user complaint text based on an arbitrary sequence, or may be filtering out the stop words in the Y historical user complaint texts and the user complaint text, and then stitching the filtered Y historical user complaint texts and the filtered user complaint text based on an arbitrary sequence, which is not limited in some implementations of the present specification. Y is a positive integer greater than 0 and less than or equal to X. The second determined threshold may be 0.6, 0.9, or the like, which is not limited in some implementations of the present specification.

Step 714: Calculate a text similarity between the description text corresponding to each change and the target complaint text.

In some implementations, the description text corresponding to each change and the target complaint text may be directly input into the BERT text similarity model, so as to output the text similarity between the description text corresponding to each change and the target complaint text. The BERT text similarity model is obtained through training based on a text similarity between each user complaint text and each of description texts corresponding to a plurality of changes, a plurality of user complaint texts, and a description text corresponding to each change.

Step 716: If a text similarity between a description text corresponding to a change and the target complaint text is greater than or equal to the first determined threshold, determine the change as a fault change corresponding to the user complaint text and the Y historical user complaint texts.

In some implementations, the change corresponding to the description text with a text similarity to the target complaint text greater than or equal to the first determined threshold may be determined as the fault change corresponding to the above-mentioned target texts, namely, the user complaint text and the Y historical user complaint texts. In other words, it is possible that the above fault change has caused the problem to occur when the users corresponding to the user complaint text and the Y historical user complaint texts use the software, and as a result, the complaint is raised, i.e., the user complaint text and the Y historical user complaint texts are generated. The first determined threshold may be 0.1, 0.9, or the like, which is not limited in the present specification. The fault change corresponding to the user complaint text and the Y historical user complaint texts includes at least one change, and the quantity of the fault changes is less than or equal to the quantity of the fault changes determined only based on the user complaint text. After determining at least one fault change related to the user complaint text, the server may send the user complaint text, the Y historical user complaint texts, and the corresponding at least one fault change to a technician corresponding to each fault change for troubleshooting, rollback, and rectification.

According to some implementations of the present specification, Y historical user complaint text, made before the complaint time of the current user complaint text, with text similarities to the user complaint text greater than or equal to the second determined threshold are stitched with the user complaint text according to a third determined rule to obtain a target complaint text, and a text similarity between the description text corresponding to each change and the target complaint text is calculated, so as to determine the fault changes corresponding to the user complaint text and the Y historical user complaint texts. As such, the problem that an incomplete description given by one user leads to inaccurate locating or the problem that there are too many fault changes suspected to be associated with the user complaint text can be avoided, and the accuracy of fault change locating can be improved. In addition, a plurality of “similar” user complaint texts can be processed at the same time, thereby greatly reducing the workload of a technician.

FIG. 8 shows a fault change locating apparatus according to some example implementations of the present specification. The fault change locating apparatus 800 includes: an obtaining module 810, configured to obtain a user complaint text; a first determining module 820, configured to determine a change set within a determined time period based on a complaint time of the user complaint text, where the obtaining module 810 is further configured to obtain a description text corresponding to each change in the change set; a first calculation module 830, configured to calculate a text similarity between the description text corresponding to each change and the user complaint text; and a second determining module 840, configured to determine a change as a fault change corresponding to the user complaint text if a text similarity between a description text corresponding to the change and the user complaint text is greater than or equal to a first determined threshold.

In some possible implementations, the description text includes at least one sentence; and the first calculation module 830 includes: a first calculation unit, configured to calculate a first word overlap score between the user complaint text and each sentence in the description text corresponding to each change, where the first word overlap score is used to represent a correlation between the user complaint text and each sentence in the description text corresponding to each change; a first extraction unit, configured to extract N sentences with highest first word overlap scores from the description text corresponding to each change, where N is a positive integer; and a second calculation unit, configured to calculate the text similarity between the description text corresponding to each change and the user complaint text based on the N sentences corresponding to each change.

In some possible implementations, the second calculation unit is, in some implementations, configured to: calculate N text similarities between the N sentences corresponding to each change and the user complaint text; and determine the text similarity between the description text corresponding to each change and the user complaint text based on L highest text similarities among the N text similarities, where L is a positive integer greater than 0 and less than or equal to N.

In some possible implementations, when determining the text similarity between the description text corresponding to each change and the user complaint text based on L highest text similarities among the N text similarities, the second calculation unit is, in some implementations, configured to: determine the text similarity between the description text corresponding to each change and the user complaint text based on the L highest text similarities among the N text similarities and L first word overlap scores between L sentences corresponding to the L highest text similarities and the user complaint text.

In some possible implementations, the description text includes a plurality of sentences; and the first calculation module 830 further includes: a stitching unit, configured to stitch all sentences in the description text corresponding to each change according to a first determined rule to obtain at least one target text corresponding to the description text, where the target text includes at least one of the sentences; a third calculation unit, configured to calculate a second word overlap score between the user complaint text and each target text corresponding to the description text, where the second word overlap score is used to represent a correlation between the user complaint text and each target text corresponding to the description text; a second extraction unit, configured to extract M target texts with highest second word overlap scores from the at least one target text corresponding to the description text, where M is a positive integer; and a fourth calculation unit, configured to calculate the text similarity between the description text corresponding to each change and the user complaint text based on the M target texts corresponding to the description text of each change.

In some possible implementations, the fourth calculation unit is, in some implementations, configured to: calculate M text similarities between the M target texts corresponding to each change and the user complaint text; and determine the text similarity between the description text corresponding to each change and the user complaint text based on K highest text similarities among the M text similarities, where K is a positive integer greater than 0 and less than or equal to M.

In some possible implementations, when determining the text similarity between the description text corresponding to each change and the user complaint text based on K highest text similarities among the M text similarities, the fourth calculation unit is, in some implementations, configured to: determine the text similarity between the description text corresponding to each change and the user complaint text based on the K highest text similarities among the M text similarities and K second word overlap scores between K target texts corresponding to the K highest text similarities and the user complaint text.

In some possible implementations, the fault change locating apparatus 800 further includes: a filtering module, configured to filter the user complaint text and the description text corresponding to each change based on a determined stop word library and according to a second determined rule (e.g., predetermined, dynamically determined, or experimentally determined) to obtain a filtered user complaint text and a filtered description text corresponding to each change; and the first calculation module 830 is, in some implementations, configured to: calculate a text similarity between the filtered description text corresponding to each change and the filtered user complaint text.

In some possible implementations, the fault change locating apparatus 800 further includes: a third determining module, configured to determine X historical user complaint texts made before the complaint time of the user complaint texts, where X is a positive integer; a second calculation module, configured to calculate a text similarity between the user complaint text and each of the X historical user complaint texts; and a stitching module, configured to: if text similarities between Y historical user complaint texts and the user complaint text are greater than or equal to a second determined threshold, stitch the Y historical user complaint texts and the user complaint text according to a third determined rule (e.g., predetermined, dynamically determined, or experimentally determined) to obtain a target complaint text, where Y is a positive integer greater than 0 and less than or equal to X; the first calculation module 830 is further configured to calculate a text similarity between the description text corresponding to each change and the target complaint text; and the second determining module 840 is further configured to: if a text similarity between a description text corresponding to a change and the target complaint text is greater than or equal to the first determined threshold, determine the change as a fault change corresponding to the user complaint text and the Y historical user complaint texts.

The division of the modules in the fault change locating apparatus is merely an example. In some other implementations, the fault change locating apparatus may be divided into different modules as required to perform all or some of the functions of the fault change locating apparatus. The modules in the fault change locating apparatus provided in some implementations of the present specification may be implemented in the form of a computer program. The computer program may run on a terminal or a server. A program module that includes the computer program may be stored in a memory of a terminal or a server. When the computer program is executed by a processor, all or some of the steps of the fault change locating method described in some implementations of the present specification are implemented.

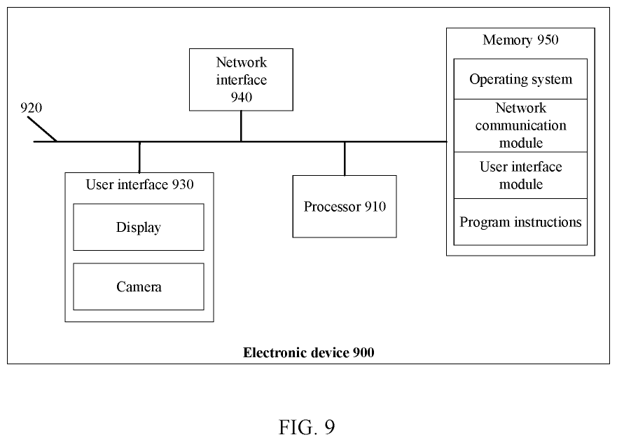

FIG. 9 is a schematic structural diagram of an electronic device according to some example implementations of the present specification. As shown in FIG. 9, the electronic device 900 may include at least one processor 910, at least one communication bus 920, a user interface 930, at least one network interface 940, and a memory 950.

The communication bus 920 may be used to implement connection and communication between the various components described above.

The user interface 930 may include a display and a camera. In some implementations, the user interface may further include a standard wired interface or wireless interface.

The network interface 940 may, in some implementations, include a Bluetooth module, a near field communication (NFC) module, a wireless fidelity (Wi-Fi) module, and the like.

The processor 910 may include one or more processing cores. The processor 910 connects all parts of the entire electronic device 900 by using various interfaces and lines, and performs various functions and data processing of the electronic device 900 by running or executing instructions, programs, code sets, or instruction sets stored in the memory 950, and invoking data stored in the memory 950. In some implementations, the processor 910 may be implemented in at least one of the following hardware forms: digital signal processing (DSP), field-programmable gate array (FPGA), and programmable logic array (PLA). The processor 910 may integrate one of, or a combination of more of the following: a central processing unit (CPU), a graphics processing unit (GPU), a modem, and the like. The CPU mainly processes an operating system, a user interface, an application, and the like. The GPU is responsible for rendering and drawing content to be displayed on the display. The modem is used to deal with wireless communication. It will be appreciated that the above-described modem may alternatively be implemented by a single chip without being integrated into the processor 910.

The memory 950 may include a random access memory (RAM), or may include a read-only memory (ROM). In some implementations, the memory 950 includes a non-transitory computer-readable storage medium. The memory 950 may be configured to store instructions, programs, code, code sets, or instruction sets. The memory 950 may include a program storage area and a data storage area. The program storage area may store instructions for implementing an operating system, instructions for implementing at least one function (such as an obtaining function, a computing function, and a determining function), instructions for implementing some above-described method implementations, etc. The data storage area may store data used in some above-described method implementations, etc. In some implementations, the memory 950 may be at least one storage apparatus far away from the processor 910. As shown in FIG. 9, the memory 950 used as a computer storage medium may include an operating system, a network communication module, a user interface module, and program instructions.

In some implementations, the processor 910 may be configured to invoke program instructions stored in the memory 950 to perform the following operations: obtaining a user complaint text; determining a change set within a determined time period based on a complaint time of the user complaint text; obtaining a description text corresponding to each change in the change set; calculating a text similarity between the description text corresponding to each change and the user complaint text; and determining a change as a fault change corresponding to the user complaint text if a text similarity between a description text corresponding to the change and the user complaint text is greater than or equal to a first determined threshold.

In some possible implementations, the description text includes at least one sentence; and when calculating a text similarity between the description text corresponding to each change and the user complaint text, the processor 910 is, in some implementations, configured to: calculate a first word overlap score between the user complaint text and each sentence in the description text corresponding to each change, where the first word overlap score is used to represent a correlation between the user complaint text and each sentence in the description text corresponding to each change; extract N sentences with highest first word overlap scores from the description text corresponding to each change, where N is a positive integer; and calculate the text similarity between the description text corresponding to each change and the user complaint text based on the N sentences corresponding to each change.

In some possible implementations, when calculating the text similarity between the description text corresponding to each change and the user complaint text based on the N sentences corresponding to each change, the processor 910 is, in some implementations, configured to: calculate N text similarities between the N sentences corresponding to each change and the user complaint text; and determine the text similarity between the description text corresponding to each change and the user complaint text based on L highest text similarities among the N text similarities, where L is a positive integer greater than 0 and less than or equal to N.

In some possible implementations, when determining the text similarity between the description text corresponding to each change and the user complaint text based on L highest text similarities among the N text similarities, the processor 910 is, in some implementations, configured to: determine the text similarity between the description text corresponding to each change and the user complaint text based on the L highest text similarities among the N text similarities and L first word overlap scores between L sentences corresponding to the L highest text similarities and the user complaint text.

In some possible implementations, the description text includes a plurality of sentences; and when calculating a text similarity between the description text corresponding to each change and the user complaint text, the processor 910 is, in some implementations, configured to: stitch all sentences in the description text corresponding to each change according to a first determined rule to obtain at least one target text corresponding to the description text, where the target text includes at least one of the sentences; calculate a second word overlap score between the user complaint text and each target text corresponding to the description text, where the second word overlap score is used to represent a correlation between the user complaint text and each target text corresponding to the description text; extract M target texts with highest second word overlap scores from the at least one target text corresponding to the description text, where M is a positive integer; and calculate the text similarity between the description text corresponding to each change and the user complaint text based on the M target texts corresponding to the description text of each change.

In some possible implementations, when calculating the text similarity between the description text corresponding to each change and the user complaint text based on the M target texts corresponding to the description text of each change, the processor 910 is, in some implementations, configured to: calculate M text similarities between the M target texts corresponding to each change and the user complaint text; and determine the text similarity between the description text corresponding to each change and the user complaint text based on K highest text similarities among the M text similarities, where K is a positive integer greater than 0 and less than or equal to M.

In some possible implementations, when determining the text similarity between the description text corresponding to each change and the user complaint text based on K highest text similarities among the M text similarities, the processor 910 is, in some implementations, configured to: determine the text similarity between the description text corresponding to each change and the user complaint text based on the K highest text similarities among the M text similarities and K second word overlap scores between K target texts corresponding to the K highest text similarities and the user complaint text.

In some possible implementations, after the obtaining a user complaint text and before the calculating a text similarity between the description text corresponding to each change and the user complaint text, the processor 910 is further configured to: filter the user complaint text and the description text corresponding to each change based on a determined stop word library and according to a second determined rule to obtain a filtered user complaint text and a filtered description text corresponding to each change; and when calculating a text similarity between the description text corresponding to each change and the user complaint text, the processor 910 is, in some implementations, configured to: calculate a text similarity between the filtered description text corresponding to each change and the filtered user complaint text.

In some possible implementations, after the obtaining a user complaint text and before the calculating a text similarity between the description text corresponding to each change and the user complaint text, the processor 910 is further configured to: determine X historical user complaint texts made before the complaint time of the user complaint texts, where X is a positive integer; calculate a text similarity between the user complaint text and each of the X historical user complaint texts; and if text similarities between Y historical user complaint texts and the user complaint text are greater than or equal to a second determined threshold, stitch the Y historical user complaint texts and the user complaint text according to a third determined rule to obtain a target complaint text, where Y is a positive integer greater than 0 and less than or equal to X; and when calculating a text similarity between the description text corresponding to each change and the user complaint text, the processor 910 is, in some implementations, configured to: calculate a text similarity between the description text corresponding to each change and the target complaint text; and when determining a change as a fault change corresponding to the user complaint text if a text similarity between a description text corresponding to the change and the user complaint text is greater than or equal to a first determined threshold, the processor 910 is, in some implementations, configured to: if a text similarity between a description text corresponding to a change and the target complaint text is greater than or equal to the first determined threshold, determine the change as a fault change corresponding to the user complaint text and the Y historical user complaint texts.

Some implementations of the present specification further provide a computer-readable storage medium. The computer-readable storage medium stores instructions. When the instructions are run on a computer or a processor, the computer or the processor is enabled to perform one or more steps in some above-described implementations. When each component module of the fault change locating apparatus is implemented in the form of a software functional unit and sold or used as an independent product, the module may be stored in the computer-readable storage medium.

All or some of above-described implementations may be implemented through software, hardware, firmware, or any combination thereof. When being implemented by software, some implementations may be implemented completely or partially in a form of a computer program product. The computer program product includes one or more computer instructions. When the computer program instructions are loaded and executed on a computer, all or some of the procedures or functions according to some implementations of the present specification are generated. The computer may be a general purpose computer, a dedicated computer, a computer network, or other programmable apparatuses. The computer instructions may be stored in a computer-readable storage medium, or may be transmitted by using the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid state disk (SSD)), or the like.

A person of ordinary skill in the art may understand that all or some of the processes of the methods in some implementations may be implemented by a computer program instructing related hardware. The program may be stored in a computer-readable storage medium. When the program runs, the processes in some method implementations are performed. The above-described storage medium includes: any medium that can store program code, such as a ROM, a RAM, a magnetic disk, or an optical disc. The technical features in some implementations and implementation solutions may be arbitrarily combined provided that there is no conflict.

Some above-described implementations are merely example implementations of the present specification, and are not intended to limit the scope of the present specification. Any variants or improvements made to the technical solutions of the present specification by a person of ordinary skill in the art without departing from the design spirit of the present specification shall fall within the protection scope determined by the claims.

Some specific implementations of the present specification are described previously. Other implementations fall within the scope of the appended claims. In some cases, actions or steps described in the claims may be performed in a sequence different from that in some implementations and desired results can still be achieved. In addition, processes described in the accompanying drawings do not necessarily require a specific order or a sequential order shown to achieve the desired results. In some implementations, multi-tasking and concurrent processing are feasible or may be advantageous.

What is claimed is:

1. A fault change locating method, comprising:
obtaining a user complaint text;
determining a change set within a time period based on a complaint time of the user complaint text;
obtaining a description text corresponding to each change in the change set;
calculating a text similarity between the description text corresponding to each change and the user complaint text; and
determining a change as a fault change corresponding to the user complaint text in response to that a text similarity between a description text corresponding to the change and the user complaint text meets a first threshold.

2. The method according to claim 1, wherein the description text includes at least one sentence; and
calculating the text similarity between the description text corresponding to each change and the user complaint text includes:
calculating a first word overlap score between the user complaint text and each sentence in the description text corresponding to each change, wherein the first word overlap score is used to represent a correlation between the user complaint text and each sentence in the description text corresponding to each change;
obtaining N sentences with highest first word overlap scores among sentences of the description text corresponding to each change, wherein N is a positive integer; and
calculating the text similarity between the description text corresponding to each change and the user complaint text based on the N sentences corresponding to each change.

3. The method according to claim 2, wherein calculating the text similarity between the description text corresponding to each change and the user complaint text based on the N sentences corresponding to each change includes:
calculating N text similarities between the N sentences corresponding to each change and the user complaint text; and
determining the text similarity between the description text corresponding to each change and the user complaint text based on L sentences having L highest text similarities among the N text similarities, wherein L is a positive integer greater than 0 and less than or equal to N.

4. The method according to claim 3, wherein determining the text similarity between the description text corresponding to each change and the user complaint text based on the L highest text similarities among the N text similarities includes:
determining the text similarity between the description text corresponding to each change and the user complaint text based on the L highest text similarities among the N text similarities and L first word overlap scores between the L sentences and the user complaint text.

5. The method according to claim 1, wherein the description text includes a plurality of sentences; and
calculating the text similarity between the description text corresponding to each change and the user complaint text includes:
stitching all sentences in the description text corresponding to each change according to a first rule to obtain at least one target text corresponding to the description text, wherein a target text of the at least one target text includes at least one of the sentences;
calculating a second word overlap score between the user complaint text and each target text of the at least one target text corresponding to the description text, wherein the second word overlap score is used to represent a correlation between the user complaint text and each target text corresponding to the description text;
obtaining M target texts with highest second word overlap scores among the at least one target text corresponding to the description text, wherein M is a positive integer; and
calculating the text similarity between the description text corresponding to each change and the user complaint text based on the M target texts corresponding to the description text of each change.

6. The method according to claim 5, wherein calculating the text similarity between the description text corresponding to each change and the user complaint text based on the M target texts corresponding to the description text of each change includes:
calculating M text similarities between the M target texts corresponding to each change and the user complaint text; and
determining the text similarity between the description text corresponding to each change and the user complaint text based on K target texts having K highest text similarities among the M text similarities, wherein K is a positive integer greater than 0 and less than or equal to M.

7. The method according to claim 6, wherein determining the text similarity between the description text corresponding to each change and the user complaint text based on the K highest text similarities among the M text similarities includes:
determining the text similarity between the description text corresponding to each change and the user complaint text based on the K highest text similarities among the M text similarities and K second word overlap scores between the K target texts and the user complaint text.

8. The method according to claim 1, further comprising:
after obtaining the user complaint text and before calculating the text similarity between the description text corresponding to each change and the user complaint text, filtering the user complaint text and the description text corresponding to each change based on a stop word library and according to a second rule to obtain a filtered user complaint text and a filtered description text corresponding to each change; and
wherein calculating the text similarity between the description text corresponding to each change and the user complaint text includes:
calculating a text similarity between the filtered description text corresponding to each change and the filtered user complaint text.

9. The method according to claim 1, further comprising:
after obtaining the user complaint text and before calculating the text similarity between the description text corresponding to each change and the user complaint text,
determining X historical user complaint texts made before the complaint time of the user complaint text, wherein X is a positive integer;
calculating a text similarity between the user complaint text and each of the X historical user complaint texts; and
in response to that text similarities between the Y historical user complaint texts and the user complaint text meets a second threshold, stitching the Y historical user complaint texts and the user complaint text according to a third rule to obtain a target complaint text, wherein Y is a positive integer greater than 0 and less than or equal to X; and
wherein calculating the text similarity between the description text corresponding to each change and the user complaint text includes:
calculating a text similarity between the description text corresponding to each change and the target complaint text; and
wherein determining the change as the fault change corresponding to the user complaint text in response to that the text similarity between the description text corresponding to the change and the user complaint text is greater than or equal to the first threshold includes:
in response to that a text similarity between a description text corresponding to a change and the target complaint text meets the first threshold, determining the change as a fault change corresponding to the user complaint text and the Y historical user complaint texts.

10. A computing system, comprising one or more processors and one or more memory devices,
the one or more processors being communicatively coupled to the one or more memory devices;
the one or more memory devices having executable program codes stored thereon, which when executed by the one or more processors enable the one or more processors to perform acts including:
obtaining a user complaint text;
determining a change set within a time period based on a complaint time of the user complaint text;
obtaining a description text corresponding to each change in the change set;
calculating a text similarity between the description text corresponding to each change and the user complaint text; and
determining a change as a fault change corresponding to the user complaint text in response to that a text similarity between a description text corresponding to the change and the user complaint text meets a first threshold.

11. The electronic device according to claim 10, wherein the description text includes at least one sentence; and
calculating the text similarity between the description text corresponding to each change and the user complaint text includes:
calculating a first word overlap score between the user complaint text and each sentence in the description text corresponding to each change, wherein the first word overlap score is used to represent a correlation between the user complaint text and each sentence in the description text corresponding to each change;
obtaining N sentences with highest first word overlap scores among sentences of the description text corresponding to each change, wherein N is a positive integer; and
calculating the text similarity between the description text corresponding to each change and the user complaint text based on the N sentences corresponding to each change.

12. The electronic device according to claim 11, wherein calculating the text similarity between the description text corresponding to each change and the user complaint text based on the N sentences corresponding to each change includes:
calculating N text similarities between the N sentences corresponding to each change and the user complaint text; and
determining the text similarity between the description text corresponding to each change and the user complaint text based on L sentences having L highest text similarities among the N text similarities, wherein L is a positive integer greater than 0 and less than or equal to N.

13. The electronic device according to claim 12, wherein determining the text similarity between the description text corresponding to each change and the user complaint text based on the L highest text similarities among the N text similarities includes:
determining the text similarity between the description text corresponding to each change and the user complaint text based on the L highest text similarities among the N text similarities and L first word overlap scores between the L sentences and the user complaint text.

14. The electronic device according to claim 10, wherein the description text includes a plurality of sentences; and
calculating the text similarity between the description text corresponding to each change and the user complaint text includes:
stitching all sentences in the description text corresponding to each change according to a first rule to obtain at least one target text corresponding to the description text, wherein a target text of the at least one target text includes at least one of the sentences;
calculating a second word overlap score between the user complaint text and each target text of the at least one target text corresponding to the description text, wherein the second word overlap score is used to represent a correlation between the user complaint text and each target text corresponding to the description text;
obtaining M target texts with highest second word overlap scores among the at least one target text corresponding to the description text, wherein M is a positive integer; and
calculating the text similarity between the description text corresponding to each change and the user complaint text based on the M target texts corresponding to the description text of each change.

15. The electronic device according to claim 14, wherein calculating the text similarity between the description text corresponding to each change and the user complaint text based on the M target texts corresponding to the description text of each change includes:
calculating M text similarities between the M target texts corresponding to each change and the user complaint text; and
determining the text similarity between the description text corresponding to each change and the user complaint text based on K target texts having K highest text similarities among the M text similarities, wherein K is a positive integer greater than 0 and less than or equal to M.

16. The electronic device according to claim 15, wherein determining the text similarity between the description text corresponding to each change and the user complaint text based on the K highest text similarities among the M text similarities includes:
determining the text similarity between the description text corresponding to each change and the user complaint text based on the K highest text similarities among the M text similarities and K second word overlap scores between the K target texts and the user complaint text.

17. The electronic device according to claim 10, wherein the acts further include:
after obtaining the user complaint text and before calculating the text similarity between the description text corresponding to each change and the user complaint text, filtering the user complaint text and the description text corresponding to each change based on a stop word library and according to a second rule to obtain a filtered user complaint text and a filtered description text corresponding to each change; and
wherein calculating the text similarity between the description text corresponding to each change and the user complaint text includes:
calculating a text similarity between the filtered description text corresponding to each change and the filtered user complaint text.

18. The electronic device according to claim 10, wherein the acts further include:
after obtaining the user complaint text and before calculating the text similarity between the description text corresponding to each change and the user complaint text,
determining X historical user complaint texts made before the complaint time of the user complaint text, wherein X is a positive integer;
calculating a text similarity between the user complaint text and each of the X historical user complaint texts; and
in response to that text similarities between the Y historical user complaint texts and the user complaint text meets a second threshold, stitching the Y historical user complaint texts and the user complaint text according to a third rule to obtain a target complaint text, wherein Y is a positive integer greater than 0 and less than or equal to X;
wherein calculating the text similarity between the description text corresponding to each change and the user complaint text includes:
calculating a text similarity between the description text corresponding to each change and the target complaint text; and
wherein determining the change as the fault change corresponding to the user complaint text in response to that the text similarity between the description text corresponding to the change and the user complaint text is greater than or equal to the first threshold includes:
in response to that a text similarity between a description text corresponding to a change and the target complaint text meets the first threshold, determining the change as a fault change corresponding to the user complaint text and the Y historical user complaint texts.

19. A non-transitory computer storage medium, the computer storage medium storing a plurality of instructions, which when executed by one or more processors enable the one or more processors to perform actions comprising:
obtaining a user complaint text;
determining a change set within a time period based on a complaint time of the user complaint text;
obtaining a description text corresponding to each change in the change set;
calculating a text similarity between the description text corresponding to each change and the user complaint text; and
determining a change as a fault change corresponding to the user complaint text in response to that a text similarity between a description text corresponding to the change and the user complaint text meets a first threshold.

20. The non-transitory computer storage medium according to claim 19, wherein the description text includes at least one sentence; and
calculating the text similarity between the description text corresponding to each change and the user complaint text includes:
calculating a first word overlap score between the user complaint text and each sentence in the description text corresponding to each change, wherein the first word overlap score is used to represent a correlation between the user complaint text and each sentence in the description text corresponding to each change;
obtaining N sentences with highest first word overlap scores among sentences of the description text corresponding to each change, wherein N is a positive integer; and
calculating the text similarity between the description text corresponding to each change and the user complaint text based on the N sentences corresponding to each change.
